(19) United States
(12) Patent Application Publication
(10) Pub. No.: US 2003/0224090 A1
(43) Pub. Date: Dec. 4, 2003

(54) Snacks of orally soluble edible films

(75) Inventors: Tony M. Pearce, Alpine, UT (US); Terry V. Pearce, Alpine, UT (US)

Correspondence Address: Parsons, Behle & Latimer, Suite 1800, 201 South Main Street, P.O. Box 45898, Salt Lake City, UT, 84111, US

(73) Assignee: EdiZONE, LC

(21) Appl. No.: 10/325,721

(22) Filed: Dec. 20, 2002

Related U.S. Application Data
(60) Provisional application No. 60/356,279, filed on Feb. 11, 2002.
(60) Provisional application No. 60/368,821, filed on Apr. 1, 2002.

(51) Int. Cl. A23L 1/00

(52) U.S. Cl. 426/89

(57) ABSTRACT

Various embodiments of snacks of orally soluble edible films are disclosed. The snacks may include one or more layers of film that is orally soluble and disintegrates quickly upon placement in a human mouth without leaving substantial residue that can be felt by the human tongue or which needs to be swallowed or ejected from the mouth.

### CLAIM FOR PRIORITY

This application claims priority to U.S. Provisional Patent Application Serial No. 60/356,279 filed on Feb. 11, 2002 and U.S. Provisional Patent Application Serial No. 60/368,821 filed on Apr. 1, 2002, each of which is hereby incorporated by reference in its entirety.

### FIELD

This disclosure pertains to the area of snacks for human consumption providing flavor satisfaction and/or craving satisfaction, including snacks that utilize orally soluble edible films with high levels of appealing flavors and/or sweeteners.

### BACKGROUND

There are a multiplicity of snacks available for human consumption, such as candy bars, hard candies, chewing gum, chips, cookies, and licorice sticks. Many of these snacks provide flavor satisfaction and/or craving satisfaction. However, they must generally be chewed or sucked and in some instances this causes disruption or undue attention such as in a classroom situation or business meeting. Further, these snacks are bulky to carry and dispensing from the packaging draws undue attention. Many of these snacks are messy, causing stickiness or crumbs or becoming visible when portions are lodged between the teeth. Further, consumption of such snacks results in ingestion of high levels of salt, fat, sugar, preservatives and other undesirable substances. There is a need for a snack for human consumption that provides the pleasure of craving and/or flavor satisfaction without the various disadvantages associated with other known snacks.

### SUMMARY

Various embodiments of snacks of orally soluble edible films are disclosed. The snacks may include one or more layers of film that is orally soluble and disintegrates quickly upon placement in a human mouth without leaving substantial residue that can be felt by the human tongue or which needs to be swallowed or ejected from the mouth.

### BRIEF DESCRIPTION OF THE DRAWINGS

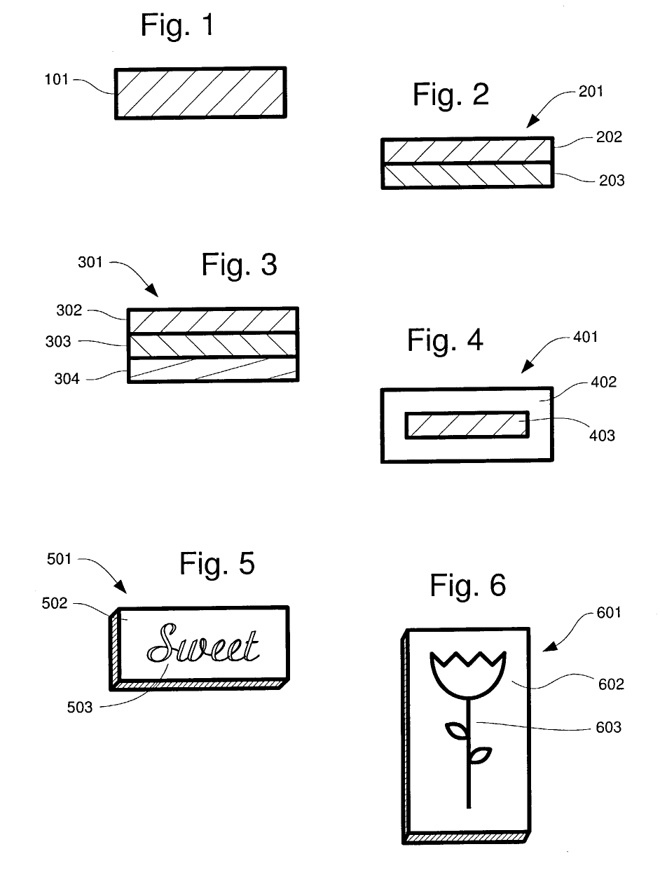

In FIG. 1, a single layer film is shown.

In FIG. 2, a film having a first layer and a second layer of like or different films laminated, bonded or laid together is depicted.

In FIG. 3, a three-layer film is depicted.

In FIG. 4, a cross-sectional view of a snack is provided that includes a film encapsulating another substance.

In FIG. 5, a view of a snack is provided that includes a film acting as a substrate for lettering or printing.

In FIG. 6, a snack is depicted that includes a film having a graphic image or figure on it.

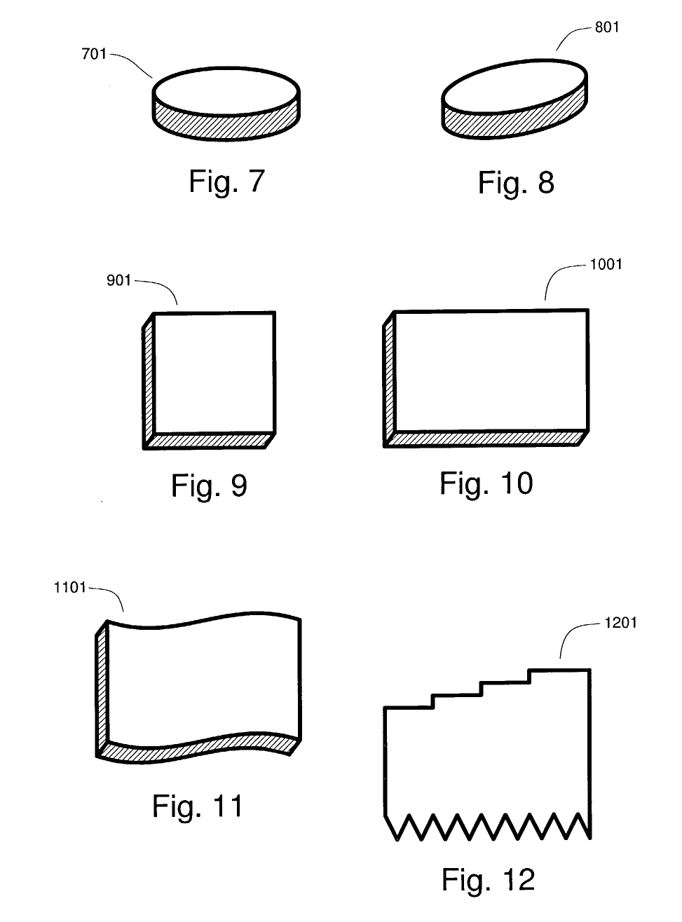

In FIG. 7, a film is depicted having a round disc shape.

In FIG. 8, a film is depicted having an oval or elliptical shape.

In FIG. 9, a film is depicted having a square shape.

In FIG. 10, a film is depicted having a rectangular shape.

In FIG. 11, a film is depicted having a curved or wavy shape.

In FIG. 12, a film is depicted having both a stepped and a jagged edge.

In FIG. 13, a snack is depicted that includes a film and gas-releasing candy located thereon.

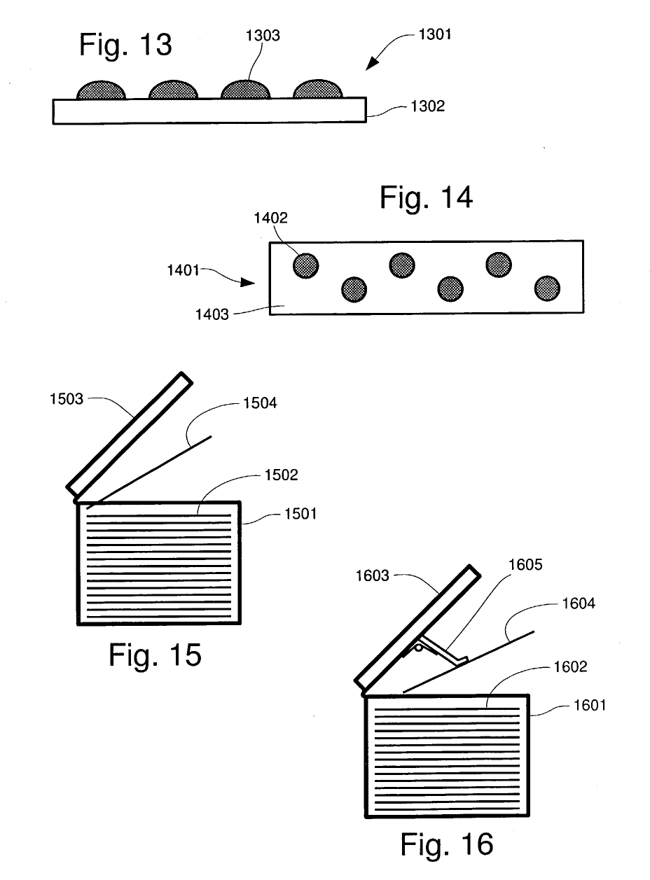

In FIG. 14, a snack is depicted that includes a film and gas-releasing candy 1403 located therein.

In FIG. 15 an example container with stacked film therein is depicted.

In FIG. 16, an example container with stacked film therein and a spring-loaded dispensing finger is depicted.

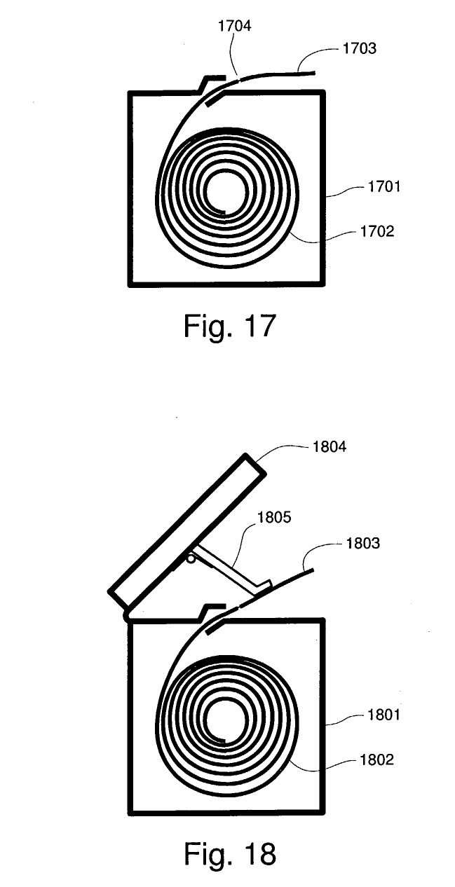

In FIG. 17, an example container with rolled film therein and a weakened or perforated portion of the film for easy removal is depicted.

In FIG. 18, an example container with rolled film therein and a spring-loaded dispensing finger is depicted.

### DETAILED DESCRIPTION

Snacks for human consumption providing flavor satisfaction and/or craving satisfaction, including snacks that utilize orally soluble edible films with high levels of appealing flavors and/or sweeteners and other ingredients are described in general and by way of specific examples below. The snacks use film that is orally soluble such that it disintegrates quickly upon placement in a human mouth without leaving substantial residue that can be felt by the human tongue or which needs to be swallowed or ejected from the mouth. The film may include at least one flavoring, the flavoring providing a strong flavor sensation to a person who places the snack on his or her tongue. A sweetener providing a sweetening sensation may also be used. The film may be one or more layers. Additional layers or materials may be provided to preserve the structure of the snack prior to use and/or to enhance or increase flavor sensations, and/or to provide a sensation of tartness, a sharp or sour flavor sensation. Such snacks avoid bulk, mess, noise when consumed, swallowing, and other disadvantages previously experienced by those persons interested in consuming snacks.

Snack Ingredients

Film-Forming Ingredients

Orally soluble edible films can include many ingredients. The base ingredients for forming a film may include water (which can be later partially or complately dried out of the film) and a film forming agent. Many other additives can be used as well for purposes of saliva stimulation, plasticizing, stabilizing, emulsifying, fillers, thickening, binding, coloring, or acting as a surfactant.

The film may include pullulan as a film-forming agent, and may also include water, additional film-forming agents, plasticizing agents, flavoring agents, sulfur precipitating agents, saliva stimulating agents, cooling agents, surfactants, stabilizing agents, emulsifying agents, thickening agents, binding agents, coloring agents, sweeteners, fragrances, and the like. Further ingredients may be added to accomplish the purposes of the film, which in the prior art are limited to breath freshening, oral hygiene, and dispensing of medicaments and nutraceuticals. Highly-concentrated snack, candy, fruit or food flavors in an orally soluble edible film may be used to meet the needs of flavor satisfaction or craving satisfaction.

Film-forming agents can include pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, polysaccharides, natural gums, polypeptides, polyacrylates, starch, karaya gum, gelatin, mixtures thereof and others. A useful film former is pullulan, in amounts ranging from about 0.01 to about 99 wt %, about 30 to about 80 wt %, from about 45 to about 70 wt % of the film or from about 60 to about 65 wt % of the film.

Film forming agents which can be used within a pullulan-free edible film include, but are not limited to, cellulose ethers; modified starches; natural gums; edible polymers; hydrocolloid flours; seaweed extracts; land plant extracts; derivatives thereof; and combinations thereof.

Examples of cellulose ethers include, but are not limited to, methylcellulose; ethylcellulose; hydroxymethylcellulose; hydroxyethylcellulose; hydroxypropylmethylcellulose; carboxymethylcellulose; derivatives thereof and combinations thereof. Modified starch examples include, but are not limited to, acid and enzyme hydrolyzed corn and potato starches. Further, examples of natural gums include, but are not limited to, gum arabic; guar gum; locust bean gum; carageenan gum; acacia; karaya; ghatti; tragacanth agar; tamarind gum; xanthan gum; derivatives thereof; and combinations thereof.

Examples of edible polymers include, but are not limited to, microcrystalline cellulose; cellulose ethers; xanthan; derivatives thereof; and combinations thereof. Moreover, examples of hydrocolloid flour include, but are not limited to, guar gum; locust bean; microcrystalline cellulose; tara; derivatives thereof and combinations thereof.

Seaweed extract examples include, but are not limited to, alginates; carageenans; derivatives thereof; and combinations thereof. Land plant extract examples include, but are not limited to, konjac; pectin; arabinoglactan; derivatives thereof; and combinations thereof.

It may be useful to avoid substantial amounts of humectant in the film (and more preferable to have no humectant in the film), so as to avoid producing an overly moist, self-adhering film. In particular, it may be useful to formulate the film with a plasticizing agent other than glycerin, which is also a humectant, and with a sweetener other than sorbitol, which is a mild humectant. In cases where over-drying of the film would result in excessive bitterness, a small amount of humectant can help a beneficial small amount of moisture in the film.

If desired, the effective amount of the film forming agent ranges from approximately about 10% to about 90%, more preferably 25% to about 75% dry weight of the film composition.

It should be appreciated by those skilled in the art, that there are other edible water-soluble film forming agents which exhibit desirable properties. A bulk filler agent may be present, especially in pullulan free edible film compositions, to reduce the “slimy” texture of the compositions. The effective amount of the bulk filler agent can be as desired or range from approximately 10% to about 90%.

An example pullulan free edible film composition can include an effective amount of carageenan as a film forming agent; an effective amount of microcrystalline cellulose as a bulk filler agent; and an effective amount of polyethylene glycol as a plasticizing agent. Additionally, to enhance the structure of the formed film, an effective amount of hydroxyethyl cellulose as a thickening agent can be incorporated

Binders

Useful binding agents include starch, in amounts ranging from about 0 to about 10 wt % or otherwise, and other binders known in the field. Other examples include casein and pullulan.

Thickeners

To further enhance the structure of the film compositions, an effective amount of at least one thickening agent may be used. Suitable thickening agents include, but are not limited to, cellulose ethers, such as hydroxyethyl cellulose, hydroxypropylmethyl cellulose, or hydroxypropyl cellulose, either alone, or mixtures thereo. Other useful thickening agents include methylcellulose, carboxyl methylcellulose, and the like, in amounts ranging from about 0 to about 20 wt % or otherwise. Polymers are also useful thickeners, such as carbomer, polyvinyl pyrrolidone, carboxymethyl cellulose, polyvinyl alcohol, sodium alginate, polyethylene glycol, natural gums like xanthan gum, tragacantha, guar gum, acacia gum, arabic gum, water-dispersible polyacrylates like polyacrylic acid, methylmethacrylate copolymer, carboxyvinyl copolymers. The concentration of a water-soluble polymer in the final film can be as desired or can vary between 20 and 75% (w/w).

Fillers

A bulk filler agent may be added to the film forming agent for many purposes, including to reduce the “slimy” texture of the compositions. The effective amount of the bulk filler can vary, and can in some instances range from approximately 10% to about 90% by dry weight of the film composition. Suitable bulk filler agents include, but are not limited to, magnesium carbonate; calcium carbonate; calcium phosphate; calcium sulfate; magnesium silicate; aluminum silicate; ground lime stone; clay; talc; titanium dioxide; microcrystalline cellulose; cellulose polymers such as wood; derivatives thereof; and combinations thereof. The useful bulk filler agent of the present invention is microcrystalline cellulose.

Plasticizers

To improve flexibility and reduce brittleness of the edible film compositions, a softener, also known as a plasticizing agent, may be used. The effective amount of the plasticizing agent of the present invention can be as desired or range from approximately 0% up to about 20% dry weight of the film composition. Typically orally soluble edible films are brittle unless plasticized.

Suitable plasticizing agents of the present invention include, but are not limited to, polyols such as sorbitol; glycerin; polyethylene glycol; propylene glycol; monoacetin; diacetin; triacetin; hydrogenated starch hydrolysates; corn syrups; derivatives thereof; and combinations thereof. A polyalcohol may be used to achieve the desired level of softness of the film. Examples of polyalcohols include glycerol (glycerine), polyethylene glycol, propylene glycol, glycerol monoesters with fatty acids or other pharmaceutically used polyalcohols. The concentration of the polyalcohol in the dry film may be as desired or can ranges between 0.1 and 5% (w/w). Some of the plasticizers are water soluble and are miscible with a polymer.

L-menthol can impart plasticization and this has been a beneficial side-effect for breath freshening films, but L-menthol can detract from the flavors of for example the fruit-flavored films of my inventions. Likewise, other plasticizing agents typically cited for film forming agents impart a bitter or otherwise very bad taste to the film, or, in the case of humectant plasticizers such as glycerin, attract moisture into the film in humid environments and cause the film pieces to undesirably adhere to adjacent film pieces. We have discovered that many of the highly-concentrated, oil-soluble flavors act as a plasticizer in their own right in the snacks, eliminating or substantially reducing the need for taste-detracting or bitter or bad tasting prior art plasticizers or humectant plasticizers.

We have discovered that many of the highly-concentrated, oil-soluble flavors that can be used in a snack act as a plasticizer in their own right in the snacks, eliminating or substantially reducing the need for taste-detracting or bitter or bad tasting prior art plasticizers or humectant plasticizers.

Some suitable plasticizers include, for example and particularly for oral-mucosal contact and other use in the oral cavity, glycerin, sorbitol, any of the glycols, polysorbate 80, triethyl titrate, acetyl triethyl titrate, and tributyl titrate.

Surfactants

Surfactants may optionally be included in the films. The purpose of including one or more surfactants in the films is to prefent beading of the hydrated film solution on the film-forming substrate, especially when the film contains oils or other non-polar materials. Useful surfactants include mono and diglycerides of fatty acids and polyoxyethylene sorbitol esters, such as, Atmos 300 and Polysorbate 80. When a combination of surfactants is used, the first component may be a polyoxyethylene sorbitan fatty acid ester or a .alpha.-hydro-.omega.-hydroxypoly (oxyethylene)poly(oxypropylene)poly(oxy-ethylene) block copolymer, while the second component may be a polyoxyethylene alkyl ether or a polyoxyethylene castor oil derivative. Other surfactants include fatty acid ester, pluronic acid, sodium lauryl sulfate, and the like. A surfactant can be added in a desired amount such as amounts ranging from about 0.5 to about 15 weight percent. In order to achieve desired instant wettability, the ratio between a first and second component of the binary surfactant mixture should be kept within 1:10 and 1:1, or within 1:5 and 1:3. The total concentration of surfactants in the final film depends on the properties of the other ingredients, but may stay between 0.1 and 5% (w/w).

Stabilizing Agents

Useful stabilizing agents include xanthan gum, locust bean gum and carrageenan, in amounts ranging from about 0 to about 10 wt % or otherwise. Other suitable stabilizing agents include guar gum and the like.

Cooling Agent

Useful cooling agents include monomenthyl succinate, in amounts ranging from about 0.001 to about 2.0 wt % or otherwise. A monomenthyl succinate containing cooling agent is available from Mane, Inc. Other suitable cooling agents include WS3, WS23, Ultracool II and the like.

Emulsifiers

If desired, an emulsifier may be included in the film. An emulsifier may be desired if the film includes oil which normally would not mix with the water component used in making the film. Emulsifiers may improve manufacturability and consistency of the film. Example emulsifying agents include casein, triethanolamine stearate, quaternary ammonium compounds, acacia, gelatin, lecithin, bentonite, veegum, and the like. Example amounts range from about 0 to about 5 wt % or otherwise.

Flavorings

The snacks can provide for craving-satisfying by including small amount of fats, oils, salt, meat flavorings or other flavorings without the customer ingesting significant amounts of those substances. Other unusual flavors may be provided as well, such as ‘apple pie ala mode’ or ‘roast beef with green peppers and onions’. By providing such flavors, the snacks can assist dieters in satisfying a craving without breaking a diet. Likewise, tart or sour flavors desired by children can be provided without interfering with their appetite while not substantially lowering the pH of the film. Substantially lowering the pH of the film may interfere with the film properties, depending on the film ingredients. An example pH of the hydrated film solution for a tart fruity flavor is 3.2 or below, or 3.5 or below, or 4.0 or below.

One aspect of the snacks is the use of more than one flavor in a film. Such a multiplicity of flavor within the mouth enhances the ingestion experience, in a similar way for example as caramel topping on vanilla ice cream. Not by way of limitation, this can be accomplished two ways: First, by using multiple feed streams of differently flavored films when casting or extruding the films; and second, by having a multiple-layer film with each layer of a different flavor. In the latter case, the film can be co-cast or co-extruded, or can be bonded together with a water soluble edible binder. For example, one layer can be caramel flavored and the other layer can be blackberry flavored. As another example, a single layer film can be striped with alternating layers that are raspberry flavored with a red color and cream flavored with a white color.

Cravings are often satisfied by fats or salts or substitutes or artificial flavoring along the same lines. An aspect of the snacks is the inclusion in an orally soluble edible film of any one or more of fats, salt, or substitutes or artificial flavoring providing a similar effect for flavor. For example, butter or cream can be included in the film. Or, an artificial butter flavor or artificial cream flavor. Examples of the use of cream flavors have been given above. Often these fats will be used in conjunction with other flavors as an enhancement. As another example, peanut oil or corn oil and salt can be included in a popcorn-flavored film for a more robust taste and better satisfaction of cravings. For the health conscious consumer, artificial butter flavoring and salt substitute such as potassium chloride can be used in the popcorn flavored film.

An aspect of the snacks is to provide for the satisfaction of cravings of, for example, dieters and health conscious consumers through orally soluble edible films containing meal and desert type flavorings and flavoring combinations. For example, apple pie ala mode has been described above. As another example, a concentrated roast beef flavor can be used in conjunction with a concentrated green pepper flavor and a concentrated onion flavor, either natural or artificial, for satisfaction of a craving for a main course of a meal. Another example is French fried potato flavored orally soluble edible film, with salt or salt substitute. The films are typically so thin that even if they contain real fat and salt, the portions are so small as to not create problems for the dieter or the health conscious consumer.

While water-based, spray-dried, alcohol/glycol-based, or semi-concentrated flavors can fulfill these aspects of the snacks, we have discovered that highly-concentrated oil-soluble flavors, whether natural or artificial or combinations thereof, can be satisfactory. Such highly-concentrated oil-soluble flavors provide sufficient flavoring to be considered intense, particularly in combination with the sweetening regimen provided below, even when delivered in the small film size suited for the mouth. The highly-concentrated, oil-soluble snack, candy, fruit or food flavors can provide the required intensity of flavor without the bitterness associated with attempts to obtain that level of flavor with water-based, spray-dried, alcohol/glycol-based, or semi-concentrated flavors. Further, since the oil-soluble flavor is not water soluble, it lingers in the mouth much longer, providing an extended period of flavor satisfaction or craving satisfaction.

The flavorings that can be used include those known to the skilled artisan, such as natural and artificial flavors. These flavorings may be chosen from synthetic flavor oils and flavoring aromatics, and/or oils, oleo resins and extracts derived from plants, leaves, flowers, fruits and so forth, and combinations thereof. Representative flavor oils include: spearmint oil, cinnamon oil, peppermint oil, clove oil, bay oil, thyme oil, cedar leaf oil, oil of nutmeg, oil of sage, and oil of bitter almonds. Also useful are artificial, natural or synthetic fruit flavors such as vanilla, chocolate, coffee, cocoa and citrus oil, including lemon, orange, grape, lime and grapefruit and fruit essences including apple, pear, peach, strawberry, raspberry, cherry, plum, pineapple, apricot and so forth. These flavorings can be used individually or in admixture. Commonly used flavors include mints such as peppermint, wintergreen, spearmint, birch, anise and such fruit flavors, as cherry, lemon-lime, orange, grape, artificial vanilla, cinnamon derivatives, and others, whether employed individually or in admixture. Flavorings such as aldehydes and esters including cinnamyl acetate, cinnamaldehyde, citral, diethylacetal, dihydrocarvyl acetate, eugenyl formate, p-methylanisole, and so forth may also be used. Generally, any flavoring or food additive, such as those described in Chemicals Used in Food Processing, publication 1274 by the National Academy of Sciences, pages 63-258, may be used. Further examples of aldehyde flavorings include, but are not limited to acetaldehyde (apple); benzaldehyde (cherry, almond); cinnamic aldehyde (cinnamon); citral, i.e., alpha citral (lemon, lime); neral, i.e. beta citral (lemon, lime); decanal (orange, lemon); ethyl vanillin (vanilla, cream); heliotropine, i.e., piperonal (vanilla, cream); vanillin (vanilla, cream); alpha-amyl cinnamaldehyde (spicy fruity flavors); butyraldehyde (butter, cheese); valeraldehyde (butter, cheese); citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, i.e. trans-2 (berry fruits); tolyl aldehyde (cherry, almond); veratraldehyde (vanilla); 2,6-dimethyl-5-heptenal, i.e. melonal (melon); 2-6-dimethyloctanal (green fruit); and 2-dodecenal (citrus, mandarin); cherry; grape; mixtures thereof; and the like.

The amount of flavoring employed is normally a matter of preference subject to such factors as flavor type, individual flavor, and strength desired. Thus, the amount may be varied in order to obtain the result desired in the final product. Such variations are within the capabilities of those skilled in the art without the need for undue experimentation. In general, amounts of about 0.1 to about 30 wt % are useable with amounts of about 2 to about 25 wt % being useful and amounts from about 3 to about 7 weight percent may be more useful.

Sweeteners

Artificial sweeteners are known to impart an aftertaste when used alone to impart sufficient sweetness to a sweetened film, and different sweeteners impart their peak sweetness at different times over the entire time that optimized flavors stay in the mouth. The snacks can provide a full level of sweetness desired without substantial aftertaste and providing at least some sweetness during the entire flavor experience.

Artificial sweeteners such as aspartame, acesulfame potassium, and sucralose can impart an aftertaste when used alone to impart sufficient sweetness to a sweetened film. In addition to this problem, different sweeteners impart their peak sweetness at different times after hydration with saliva. Use of one sweetener alone thus will not impart the sweetness desired over the entire time that optimized flavors stay in the mouth, being too early or too late. Prior films try to address this with a combination of two of these sweeteners. We have found that such combinations of two sweeteners must still be at such levels that an aftertaste is experienced, and do not give the desired sweetness over the full flavor experience. Thus an aspect of the snacks is to use all three of these sweeteners in small amounts to achieve the full level of sweetness desired without substantial aftertaste and providing at least some sweetness during the entire flavor experience.

We have discovered that a tripartite admixture of three different sweeteners is highly effective at producing a desirable snack. Rather than mixing the sweeteners in equal amounts by weight or volume, we have found it particularly useful to mix them in equal amounts of sweetness potency.

Suitable sweeteners that can be included are those well known in the art, including both natural and artificial sweeteners. Suitable sweeteners include, e.g.:

A. water-soluble sweetening agents such as monosaccharides, disaccharides and polysaccharides such as xylose, ribose, glucose (dextrose), mannose, galactose, fructose (levulose), sucrose (sugar), maltose, invert sugar (a mixture of fructose and glucose derived from sucrose), partially hydrolyzed starch, corn syrup solids, dihydrochalcones, monellin, steviosides, and glycyrrhizin;

B. water-soluble artificial sweeteners such as the soluble saccharin salts, i.e., sodium or calcium saccharin salts, cyclamate salts, the sodium, ammonium or calcium salt of 3,4-dihydro-6-methyl-1,2,3- -oxathiazine-4-one-2, 2-dioxide, the potassium salt of 3,4-dihydro-6-methyl-1,2,3-oxathiazine-4-one-2,2-dioxide (acesulfame-K), the free acid form of saccharin, and the like;

C. dipeptide based sweeteners, such as L-aspartic acid derived sweeteners, such as L-aspartyl-L-phenylalanine methyl ester (aspartame) and materials described in U.S. Pat. No. 3,492,131, L-alpha-aspartyl-N-(2,2,4,4-tetramethyl-3-thietanyl)-D-alaninamide hydrate, methyl esters of L-aspartyl-L-phenylglycerin and L-aspartyl-L-2,5,dihydrophenyl-glycine, L-aspartyl-2,5-dihydro-L-phenylal-anine, L-aspartyl-L-(1-cyclohexyen)-alanine, and the like;

D. water-soluble sweeteners derived from naturally occurring water-soluble sweeteners, such as a chlorinated derivative of ordinary sugar (sucrose), known, for example, under the product description of sucralose; and

E. protein based sweeteners such as thaumatoccous danielli (Thaumatin I and II).

Other sweeteners may be used as well.

Sour Snacks

One difficulty in making good tasting flavor films is in providing highly sour flavors, for example sour apple or sour lemon or sour peach. Sourness, or tartness, is generally caused by low pH. Low pH is known to adversely effect nearly all of the film forming ingredients, causing for example brittleness, low tensile strength, and short shelf life. One solution that we have discovered is to combine the snack, candy, fruit or food flavors, the acid required to cause the desired tartness, and pullulan (as a film forming ingredient), since this combination is less effected (though still somewhat effected) than other combinations which use as the film former starches or gums. Another solution we have discovered is to have the acid in a separate layer from the film. For example, as the film is drying, the acid can be applied in powder form (optionally diluted by a filler material such as maltodextrin) to the exterior of the film (optionally with a binder material to enhance the adhesion to the film). In this way, the acid does not penetrate the film itself to a degree great enough to deteriorate the film. This discovery is particularly exciting because the acid in this case may be the first thing to contact the tongue, so the burst of sour is first even before the flavor, which is desirable in many types of candy snacks. We have also discovered a way to make the sour flavor last longer. This is done through the same method of having the acid in a separate layer, except that some or all of the acid is microencapsulated to create a delay in solvation. Using a mixture of acids with different degrees of delay in solvation can make the sour flavor last. The sour flavor can last at least as long as the highly-concentrated oils which linger in the mouth. The acid can also be put in other locations than on the exterior. For example, it can be put between two layers of film which are bound together by the binding agent that is with the acid. In this case, the film flavor would be tasted first, then the sour, which is desirable in some instances. Common edible acids are citric, tartaric and maleic, and we have found that tartaric acid is especially advantageous, especially when it is an ingredient of the film rather than coated on the exterior. Tartaric acid provides considerable sourness or tartness for the amount of volume occupied, which in such thin films is advantageous.

Effervescence

An optional aspect of the snacks is the inclusion of the property of effervescence.

Advantages of effervescence include without limitation the delight of children and the more effective coating of the oral cavity with the flavors. The effervescence can be in the form of loud snappy bubbles or quiet foamy bubbles or any combination thereof. Loud snappy bubbles are obtained by the inclusion of small bits of a gas-releasing agent in the snack.

Gasified candy is usually hard candy containing gas, such as carbon dioxide. Such a candy may be made by a process which comprises melting crystalline sugar, contacting such sugar with gas at a pressure of 50 to 1,000 psig for a time sufficient to permit incorporation in said sugar of 0.5 to 15 cc of gas per gram of sugar, maintaining the temperature of said sugar during said absorption above the solidification temperature of the melted sugar, and cooling said sugar under pressure to produce a solid amorphous sugar containing the gas. Upon the release of the pressure, the solid gasified candy fractures into granules of assorted sizes.

The resultant product may contain 1% to 4% water and most typically 2% to 3% water by weight of the total composition. (All figures expressed herein as a percentage are in terms of weight percent, unless specifically expressed to the contrary.) Lower levels of moisture may not be practicably obtainable because the additional heat necessary to drive off the water causes the candy melt to caramelize or burn, resulting in an off-flavor, undesirable product. High moisture levels result in a soft, sticky matrix which rapidly liberates the entrapped gas and is thus not storage stable.

The gasified candy, when placed in the mouth, produces an entertaining but short-lived popping sensation. As the candy is wetted in the mouth the candy melts and the gas escapes. The tingling effect in the mouth is sensational but short.

When the solidified gasified candy is fractured by the release of pressure from the preparation vessel, the resultant granulated pieces are irregular, randomed-sized pieces having the appearance of pieces of broken glass or what might be termed sharp-faced pieces of gravel. The granulated pieces are sieved to provide the gasified candy in a range of particle sizes.

A process may be used wherein the sugar is maintained above its fusion temperature of 25 degrees to 200 degrees. C. (77 degrees to 392 degrees F.) while the gas, at a pressure of 50-1000 psig, is contacted with the sugar melt for 2 to 6 minutes. Mixtures of sugar are held at 150 degrees or 160 degrees. C. (302 degrees or 320 degrees F.) while carbon dioxide at 600 psig is mixed into the liquid sugar for a short period of time, usually about six minutes. Example processes utilize a sugar melt maintained at 315 degrees to 325 degrees F. while carbon dioxide at 600 psig is brought into contact with the sugar.

In producing gasified candy by a commercial process conducted in accordance with this disclosures, gasified candy may be produced from a mixture of sucrose, lactose and corn starch dissolved in water and evaporated to a sugar melt containing about 2 to 3% water. Carbon dioxide may be maintained at 625 to 675 psig in the pressure vessel containing the sugar melt while the vessel contents are mixed for 4 to 6 minutes. The sugar melt may be held at about 295 degrees. F. during the gasification. Following the gasification, the gasified melt may be transferred to a water-jacketed cooling tube where it is held for 2½-3 hours at a pressure which is 50 psi higher than the gasification pressure. At the end of the cooling cycle, the pressure may be released from the cooling tube which causes the solidified gasified candy to shatter into multiple fragments.

As used herein “observable gas bubbles” means those gas bubbles which can be seen when the solidified gasified candy is observed through light microscopy. The observable bubbles are generally classified into large bubbles, i.e., those having a diameter of about 100 mu. and above and small bubbles, i.e., those having a diameter below about 100 mu. The small bubbles are generally not considered to be significant since they do not contribute to the popping sensation.

Gasified candy which produces a more pronounced popping sensation can be prepared by utilizing low preparation temperatures. The gasified candy product obtained by this improved process contains observable gas bubbles having a maximum diameter substantially larger than those in the commercial product produced heretofore. For example, observable large gas bubbles with a diameter in the range of about 150 to about 225 mu. may be produced, or large gas bubbles with a diameter above about 225 mu. and more particularly in the range of about 300 to about 350 mu.

A sugar melt may be gasified at superatmospheric pressure and the gasified sugar melt is cooled below its fusion temperature under superatmospheric pressure to form a gasified candy. In particular, steps utilized may include maintaining the sugar melt during the gasification at a temperature effective to produce in the gasified candy product observable gas bubbles wherein the majority of the large observable gas bubbles have a diameter of above about 225 mu.

The product may include a gasified candy comprising a solidified fused sugar containing therewithin bubbles of gas, said gas being at superatmospheric pressure and said observable bubbles having a maximum diameter of about 350 mu.

The gasified candy component of the snack may be a hard sugar product having bubbles of gas entrapped therein and is conveniently produced as described below or otherwise. The gasified candy can be prepared from any of the commercially-available sugars employed in the confectionary industry. Thus, such sugars as glucose, fructose, sucrose, lactose and the like, alone or in combination, may be employed. A mixture of sucrose with corn syrup (containing glucose, maltose, dextrin) may also be satisfactory. A mixture of sucrose, lactose and corn syrup in a weight ratio of 52:27:21 may be useful, providing a gasified hard product particularly characterized by its good gas retention and reduced stickiness on standing. A 40:40:20 mixture of sucrose, lactose and corn syrup may also be useful since it additionally should provide good high temperature stability. The moisture content of the gasified candy should be between 1.0 and 5.0% or between 2.0 and 3.0%.

The gases used to prepare the gasified candy may be any of the commonly-available gases which are substantially unreactive with the sugar or sugars being employed and include such gases as carbon dioxide, nitrogen or air, but carbon dioxide is useful.

The gasified candy may be employed in granulated form and is most easily provided in that form following the solidification of the gasified sugar in the preparation vessel or in a separate cooling tube provided for this purpose. The release of pressure from the vessel fractures the gasified sugar into granulated pieces in a wide range of assorted sizes. Although finely divided pieces of gasified candy in a variety of sizes may be employed, the pieces may be sieved to provide uniform sized pieces. In general, smaller sized pieces may be more useful. Gasified candy having a particle size distribution of −4 to +40 U.S. Sieve Series can be employed, or from −4 to +14 U.S. Sieve Series.

A sugarless form of gasified candy can also be employed by substituting sugarless material, such as sorbitol, for the sugar in the gasified candy preparation described herein.

The gasified candy may be prepared in accordance with the examples and steps described below or otherwise.

The sugar or mixtures of sugars are placed in a heated vessel provided with a mixer. A small quantity of water is added to dissolve the sugar and other additives. Heat is applied to the vessel sufficient to dissolve the sugars. The mixture is then evaporated to produce a melt having 1-5%, preferably 2-3%, of water. The required amounts of coloring, flavoring and/or active ingredient may be added when the desired water content is achieved. The evaporation may be conducted at atmospheric pressure or, preferably, under a vacuum of up to 15 inches of mercury. Melt temperatures of between about 280 degrees to 320 degrees F. may be necessary to reach the desired moisture content. Care should be exercised to prevent caramelizing the sugary mix.

The next step is to gasify the sugar melt and it is in this particular step that the temperature of the sugar melt is critical when practicing the process described herein. The temperature at which the melt is maintained while the gas is being incorporated therein affects the “pop” of the product, i.e., the quality of the popping sensation produced by the gasified candy. Lower melt temperatures promote larger gas bubbles because both the viscosity and the surface tension of the melt is increased as the temperature is reduced and bubble diameter is proportional to both viscosity and surface tension. Melt temperatures that produce observable gas bubbles having a maximum diameter of about 350 mu. are satisfactory. Maximum melt temperatures of about 280 degrees F. should achieve this desired result and produce a product with a good “pop”. The larger the gas bubbles entrapped in the solidified candy, the more pronounced the popping when the candy is eaten. Observable bubbles having a maximum diameter of about 350 mu may be produced when the melt temperature during gasification is below about 280 degrees F. and the mixing time is about 4-6 minutes.

The sugar melt is gasified by introducing gas, such as carbon dioxide, at superatmospheric temperature into the closed vessel. Pressures of about 50-1000 psig, preferably about 500-700 psig, are utilized. While the required amount of gas is being introduced into the closed vessel, the liquid melt is agitated to effect intimate contact between the gas and the melt. Sufficient gas is incorporated into the melt to provide 0.25-7.0 cc. of gas per gram of candy in the final product. The gasification is completed within a fairly short period of time, such as about 10 minutes or 2 to 6 minutes. During this time, the melt is maintained at a maximum temperature as explained above. The required amount of mixing may be readily determined by those skilled in the art. For example, using a Parr bomb (a small pressure vessel equipped with a mixer) to prepare about 1,000 grams of melt, mixing speeds of 200-1500 rpm, preferably 500-900 rpm, may be used.

The gasified melt is then permitted to solidify while maintaining the vessel under pressure. Where desired, the solidification may be conducted in a cooling tube. Bubbles of gas are entrapped in the solidified sugar. After the melt has solidified, the pressure is released, which fractures the sugary mass into granulated pieces of a variety of sizes.

The following example is illustrative.

1,000 grams of sucrose, lactose and corn syrup in a weight ration of 52:27:21 were dissolved in water and evaporated at a temperature of 320 degrees F. atmospherically to produce a melt having a moisture content of about 3%. This melt was placed in a pre-heated Parr bomb (a small pressure vessel equipped with a mixer). The bomb was placed in a controlled temperature bath and pressurized with carbon dioxide at 750 psig for five minutes during which time the sugar melt was mixed vigorously. Following the carbonation, the pressure was maintained while the vessel was cooled so as to solidify the sugar melt. Rapidly releasing the pressure fractured the solidified carbonated candy into multiple pieces of various sizes.

For example, the bits of candy can be inserted into an encapsulant film made of orally soluble edible film in means as described above. As another example, the bits of pressurized-gas candy can be coated on the film, either as it dries or by use of a binder. As another example, the bits of pressurized-gas candy can be put between layers of orally soluble edible film. The flavor in the film can be the same or different than the flavor in the pressurized-gas candy. The advantage of combining pressurized-gas candy with film, as opposed to having the bits of candy sold in a pourable envelope, include lack of messiness and the ability to put a consistent pre-measured amount into the oral cavity each time. When the film so made is placed into the oral cavity, the pressurized-gas candy is solvated to release the pressurized gas, and loud snappy effervescence results. This can be very entertaining to the user. The second type of effervescence is the quiet foamy type. This can be obtained by mixing ingredients such as sodium bicarbonate and citric acid in the presence of water. Since sodium bicarbonate and citric acid are both dry, they can co-exist in the same film, and when water (saliva) is added, gas bubbles will form. One example is to make a two layer film, wherein the top layer contains sodium bicarbonate and the bottom layer contains citric acid. The two layers can be joined with a binder. Another example is to have a one-layer film containing sodium bicarbonate, and put a dry coating of citric acid on one or both sides of the film. This will provide the consumer with an often-desired sour taste, followed promptly by effervescence.

Film Structure and Shape

Film used in the snacks may be of a variety of structures and shapes as described herein or otherwise.

### EXAMPLE STRUCTURES

Referring to FIG. 1, a single layer film 101 of generally homogenous material is depicted. The film 101 may or may not include an exterior coating (not shown), such as an acid to effect a sour taste, a powder to reduce tackiness, or another coating.

Referring to FIG. 2, a film 201 having a first layer 202 and a second layer 202 of like or different films laminated, bonded or lain together is depicted.

Referring to FIG. 3, a three-layer film 301 is depicted having a first layer 302, a second layer 302 and a third layer 303. The layers may be the same or a different material.

Referring to FIG. 4, a cross-sectional view of a snack 401 is provided that includes a film 402 encapsulating another substance 402.

Referring to FIG. 5, a view of a snack 501 is provided that includes a film 502 acting as a substrate for lettering or printing 503. The lettering 503 may be atop the film 502 or embedded or embossed or cast or molded or stamped or located within it.

Referring to FIG. 6, a snack 601 is depicted that includes a film 602 having a graphic image or FIG. 603 on it.

Referring to FIG. 7, a film 701 is depicted having a round disc shape.

Referring to FIG. 8, a film 801 is depicted having an oval or elliptical shape.

Referring to FIG. 9, a film 901 is depicted having a square shape.

Referring to FIG. 10, a film 1001 is depicted having a rectangular shape.

Referring to FIG. 11, a film 1101 is depicted having a curved or wavy shape.

Referring to FIG. 12, a film 1201 is depicted having both a stepped and a jagged edge.

Referring to FIG. 13, a snack 1301 is depicted that includes a film 1302 and gas-releasing candy 1303 located thereon.

Referring to FIG. 14, a snack 1401 is depicted that includes a film 1402 and gas-releasing candy 1403 located therein.

Encapsulation

The snacks can also provide for encapsulation of other non-film materials. Encapsulating non-film edible materials such as flavored oils, medicaments, breath fresheners, antiseptic, antimicrobial, nutraceuticals, candy, and the like can be achieved through layering or through a containment chamber within the snack.

An aspect of the snacks is the use of orally soluble edible films for encapsulation of other materials which are desirably output into the oral cavity when the encapsulating film dissolves. This is different than the prior art method of encapsulating medicament pills or neutraceutical pills with edible soluble coatings, since in those cases the intent of the coating is to prevent the medicament or neutraceutical from being released in the oral cavity, but allow its release in the stomach or intestine. In the case of the snacks, it is the intention to allow the saliva to dissolve away the film encapsulant and release the contents into the oral cavity. Not by way of limitation, the contents could be flavored, sweetened vegetable oil for flavor satisfaction or craving satisfaction or special flavor effects such spicy hot or sour, or medicaments intended for the oral cavity, or breath fresheners, or candy of any type, or fats or creams. For example, the film encapsulant can be an orally soluble edible film of the snacks as described above with an apple pie and cinnamon flavor, and the contents can be a cream type candy. When placed in the oral cavity, the consumer first tastes the apple pie, and then when the film dissolves to release the contents, tastes the cream. In this way the consumer gets a sensation similar to apple pie ala mode. As another example, the orally dissolvable edible film encapsulant may have a pleasant sweetened spearmint taste, and the contents may contain essential oils such as menthol or peppermint. In this way the user experiences a pleasant candy-like mint flavor and ends with a fresh-feeling mouth and the sensation of fresh breath. Encapsulation can take many forms, and the following examples are not by way of limitation. The film can be formed into an envelope, the contents placed within, and the envelope flap closed by tucking or sealing, such as heat sealing or use of a binder for sealing. Or, the film can be formed into a pouch, the material placed into an open end, and the pouch sealed closed. Or, the film can be directly coated onto the contents using pill coating techniques. Or, the film can be made into a two piece capsule such as those used to contain neutraceuticals or medications, such as a specially formulated gelatin capsule, the contents inserted, and the two pieces put together. Or, the film can be made whole around a liquid center by using the known techniques and equipment used to make for example vitamin E capsules.

Avoiding Medicinal Taste

Some films in the past utilized L-Menthol as a plasticizer necessary for successful film formation. L-Menthol is also a breath freshener which if used in snacks would detract from and interfere with their pleasant flavor. The snacks described herein may be made generally L-Menthol free to avoid a medicinal taste.

Flavor Release Rate

Some of the snacks described herein will have a flavor release rate that imparts flavor to the human tongue in less than 1 second, less than 2 seconds, less than 3 seconds, or otherwise. The flavor can last up to 2 or 3 minutes or more. Other flavor release rates are possible.

Film or Snack Shape

If desired, the perimeter of the snack may be shaped other than traditional square or rectangular shapes. For example, shaping the film in the form of animals or stars for the delight of children. Or, for example, shaping the film into a company logo or movie character for promotional or advertising purposes. Or, for examples shaping the film into numbers and letters to be used by children in play much in the same way that the letters in alphabet soup are used. Or, for example, to differentiate one type of film-based medicament or nutraceutical from another, just as prescription medications and vitamin tablets come in unique shapes to differentiate one from another. Not by way of limitation, in flat films, this may be accomplished by standard die cutting techniques. In many cases, the left-over film from the die cutting process can be rehydrated and used again to make new film, thus making the process cost efficient.

An aspect of the snacks is to go beyond flat films into three dimensional films. This can have the same advantages as cited for films with non-rectangular perimeter shapes. This may be done with films in which the film forming agent or a binder thereof has thermoplastic properties. Pullulan is an excellent example of an orally soluble edible film former with thermoplastic properties. This can be accomplished by post-forming the flat film by methods including compression forming and embossing, or by other means used for forming thermoplastics including extrusion and injection molding. It can also be accomplished by putting the hydrated film solution onto shaped surfaces and then drying the film. Delight, entertainment, education, promotion, and differentiation can be achieved by selection of shapes. For example, the films can be shaped into various types of dinosaurs and sold as candy, educating children as to the different types of dinosaurs.

Artwork

Images

In order to increase the attractiveness of the snacks to the consumer, they may include an exterior surface with an embossed, sculpted, sprayed or printed image, figure, logo, text, graphics, characters, art or words. Edible ink may be used for such optical images. Such optical representations may be related or unrelated to the flavor that the snack provides. Such optical representations may be chosen to cause the consumer to experience pleasant thought when consuming the snack, to attract the consumer's attention in a retail location, for advertising, education other related or unrelated products, or for other reasons. In general the optical images are provided to make the product more entertaining and delightful than it would be without the optical images. The snacks decribed herein can provide an aesthetic and pleasing appearance through the use of bright and/or multiple colors. The films may be brightly colored and entertaining. Multiple colors may be used including those that intentionally color the human tongue. Glow in the dark materials may be included in order to make the tongue glow in darker locations, such as at dances, in bars, etc. Printing is desirable for other reasons as well. The promotional and advertising industries will benefit by placing logos and other promotional and advertising on the film. Sweepstakes and contest winners could find their prize on the film. Comic strips could be printed on the film, especially on continuous roll-type film. Depending on the type of film, particularly for medicament films or neutraceuticals films, it may be important to print instructions and warnings on the film. Printing, particularly in multiple colors, can also provide visual stimulation, delight, and/or entertainment, especially to youngsters. For example, characters from a loved television show or movie can be printed on the film. The film can be more educational and entertaining by inclusion of for example riddles and questions, with the answer on the next piece of film or further down the roll or on the other side of the film. It may be important to put trademarks on the film. It may be desirable to print the name of the product on the film to aid in increasing brand awareness. The film can be printed on one side or both sides.

Printing of text, graphics, photographs or combinations thereof onto orally soluble edible films, including but not limited to the snack, candy, fruit or food flavored films may be accomplished through standard printing techniques in combination with the use of edible inks. Alternatively, it may be accomplished with different colored films melded together. Not by way of limitation, two types of inks may be employed. The first type is an ink made from a solution containing the same film forming ingredient as in the orally soluble edible film being printed upon, to which dye or pigment is added. The second type are commonly available vegetable dies. The printing can be done in one or more colors, and it may done while the film is in roll form (prior to being cut for individual packaging) or as it comes off the film line and is heading toward the roller. The ink can be flavorless, or can add more of the same type of flavor as is in the film, or can add one or more additional flavors, or can add salivary stimulants which will help produce saliva to dissolve the film, or can add tartness or sourness. This last is important since tartness is created by the addition of acid, which if put into the film itself, can harm the desired physical properties of the film. This is true of most film bases. Printed on the exterior of the film, the acid will provide the initial sour flavor burst desired by many children and other consumers, but will not adversely affect the film.

Coloring

The snacks can use bright or multiple colors, as compared with the muted colors of the prior art. While these may be printed onto the film as previously described, the pigment or dye may be included within the film itself in sufficient intensity to be bright and pleasing to the eye. Further, multiple colors, whether bright or muted, can be used within the same film. Not by way of limitation, this can be accomplished two ways: First, by using multiple feed streams of different colors when casting or extruding the films; and second, by have a multiple-layer film with each layer of a different color. In the latter case, the film can be co-cast or co-extruded, or can be bonded together with a water soluable edible binder. While in most films it would not be desirable for the film to leave color in the mouth, a further aspect of the snacks especially for children's films is to use the type of dye, such as vegetable dyes, that leave the child's tongue and/or teeth temporarily colored after ingestion.

The coloring agents are used in amounts effective to produce the desired color. Some coloring agents include pigments such as titanium dioxide, may be incorporated in amounts of up to about 5 wt % or more. Colorants generally include natural food colors and dyes suitable for food, drug and cosmetic applications. These colorants are known as FD&C dyes and lakes. The materials acceptable for the foregoing spectrum of use could be water-soluble, and include FD&C Blue No. 2, which is the disodium salt of 5,5-indigotindisulfonic acid. Similarly, the dye known as Green No. 3 comprises a triphenylmethane dye and is the monosodium salt of 4-[4-N-ethyl-p-sulfobenzylamino) diphenyl-methylene]-[1-N-ethyl-N-p-sulfonium benzyl)-2,5-cyclo-hexadienim-ine]. A full recitation of all FD&C and D&C dyes is available in industry literature.

Medicaments and Nutraceuticals

With various films, particularly where the film encapsulates or is layered with another material, it may be desirable to include ingredients, especially in the encapsulated or co-layered material, other than mere sweeteners and flavoring, such as a bactericide, antiseptic, antimicrobial, stimulant, vitamin or other medicament or nutraceutical. The fast dissolving film may include at least one physiologically acceptable, pharmaceutically active agent. The expression “physiologically acceptable” as used herein is intended to encompass compounds, which upon administration to a patient, are adequately tolerated without causing undue negative side effects. The expression encompasses edible compounds.

The expression “pharmaceutically active agents” as used herein is intended to encompass agents other than foods, which promote a structural and/or functional change in and/or on bodies to which they have been administered. These agents are not particularly limited; however, they should be physiologically acceptable and compatible with the film. Suitable pharmaceutically active agents include, but are not limited to:

A. antimicrobial agents, such as triclosan, cetyl pyridium chloride, domiphen bromide, quaternary ammonium salts, zinc compounds, sanguinarine, fluorides, alexidine, octonidine, EDTA, and the like,

B. non-steroidal anti-inflammatory drugs, such as aspirin, acetaminophen, ibuprofen, ketoprofen, diflunisal, fenoprofen calcium, naproxen, tolmetin sodium, indomethacin, and the like,

C. anti-tussives, such as benzonatate, caramiphen edisylate, menthol, dextromethorphan hydrobromide, chlophedianol hydrochloride, and the like,

D. decongestants, such as pseudoephedrine hydrochloride, phenylepherine, phenylpropanolamine, pseudoephedrine sulfate, and the like,

E. anti-histamines, such as brompheniramine maleate, chlorpheniramine maleate, carbinoxamine maleate, clemastine fumarate, dexchlorpheniramine maleate, diphenhydramine hydrochloride, diphenylpyraline hydrochloride, azatadine meleate, diphenhydramine citrate, doxylamine succinate, promethazine hydrochloride, pyrilamine maleate, tripelennamine citrate, triprolidine hydrochloride, acrivastine, loratadine, brompheniramine, dexbrompheniramine, and the like,

F. expectorants, such as guaifenesin, ipecac, potassium iodide, terpin hydrate, and the like,

G. anti-diarrheals, such a loperamide, and the like,

H. H.sub.2-antagonists, such as famotidine, ranitidine, and the like; and

I. proton pump inhibitors, such as omeprazole, lansoprazole, and the like,

J. general nonselective CNS depressants, such as aliphatic alcohols, barbiturates and the like,

K. general nonselective CNS stimulants such as caffeine, nicotine, strychnine, picrotoxin, pentylenetetrazol and the like,

L. drugs that selectively modify CNS function such as phenyhydantoin, phenobarbital, primidone, carbamazepine, ethosukimide, methsuximide, phensuximide, trimethadione, diazepam, benzodiazepines, phenacemide, pheneturide, acetazolamide, sulthiame, bromide, and the like,

M. antiparkinsonism drugs such as levodopa, amantadine and the like,

N. narcotic-analgesics such as morphine, heroin, hydromorphone, metopon, oxymorphone, levorphanol, codeine, hydrocodone, xycodone, nalorphine, naloxone, naltrexone and the like,

O. analgesic-antipyretics such as salycilates, phenylbutazone, indomethacin, phenacetin and the like,

P. psychopharmacological drugs such as chlorpromazine, methotrimeprazine, haloperidol, clozapine, reserpine, imipramine, tranylcypromine, pheneizine, lithium and the like.

The amount of medicament that can be used in the rapidly dissolving films is dependent upon the dose needed to provide an effective amount of the medicament.

The films that deliver a medicament can also include a triglyceride. Examples of triglycerides include vegetable oils such as corn oil, sunflower oil, peanut oil, olive oil, canola oil, soybean oil and mixtures thereof. The triglyceride may be added to the film in amounts from about 0.1 wt % to 16 about 12 wt % or otherwise.

The films that contain medicaments also can include a preservative. The preservative may be added in amounts from about 0.001 wt % to about 5 wt %, preferably from about 0.01 wt % to about 1 wt % of the film. Useful preservatives include sodium benzoate and potassium sorbate.

The medicament containing films can also include a polyethylene oxide compound. The molecular weight of the polyethylene oxide compound can range from about 50,000 to about 6,000,000. A useful polyethylene oxide compound is N-10 available from Union Carbide Corporation. The polyethylene oxide compound may be added in amounts from about 0.1 wt % to about 5 wt % or otherwise.

The medicament containing films can also include propylene glycol. The propylene glycol may be added in amounts from about 1 wt % to about 20 wt % or otherwise.

The active ingredient used in the film can be coated to mask the taste of the active ingredient or to prevent the active ingredient from numbing the tongue or other surfaces in the oral cavity. The coatings that can be used are known to those skilled in the art. These include polymers such, as Eudragit.RTM., cellulosics, such as ethylcellulose, and the like.

An additional way to mask the taste of the active ingredient is by using an ion exchange resin such as Amberlite RP-69, available from Rohm and Haas, and Dow XYS-40010.00, available from the Dow Chemcial Co.

Sulfur Precipating Agents

Sulfur precipitating agents that reduce oral malodor can also be added to the films or to the encapsulated or co-layered material. These agents bind with, and inactivate, the volatile sulfur compounds that cause a large percentage of oral malodor. Sulfur precipitating agents that may be useful include metal salts such as copper salts and zinc salts. Useful salts include copper gluconate, zinc citrate and zinc gluconate. The amount of sulfur precipitating agent may be from about 0.01 to about 2 wt %, from about 0.15 wt % to about 1.5 wt %, or from about 0.25 wt % to about 1.0 wt % of the film.

Saliva Stimulating Agents

Saliva stimulating agents can also be added to the films or to the encapsulated or co-layered material. Saliva stimulating agents include food acids such as citric, lactic, malic, succinic, ascorbic, adipic, fumaric and tartaric acids. Useful food acids are citric, malic and ascorbic acids. The amount of saliva stimulating agents in the film may be from about 0.01 to about 12 wt %, from about 1 wt % to about 10 wt %, or from about 2.5 wt % to about 6 wt %, or otherwise.

Film or Snack Packaging

Various containers are provided that provide easy dispensation of the snacks and can provide advertising, labeling, logos, cartoon characters or other information or serve other functions

Breath freshening and oral care films have been marketed in flat containers with a flip top that snaps shut. This is a non-bulky solution to putting a short stack of film pieces in a pocket or purse. However, this type of container does not meet the needs or wants of users in many situations. One problem is that the films are stacked, and sometimes become lightly adhered to one another, especially in humid environments. Even when not adhered, it can be difficult to slide the film out of the container while leaving the other films behind, because to be successful the method requires proper technique, dexterity, and involves the use of the finger which will vary in its friction characteristics from person to person and day to day, and will be seen as non-hygienic by some. New dispensers for orally soluble edible films can be provided which have one or more of the following functions as compared with prior flat flip-top containers: greater ease or reliability of dispensing, an aesthetically pleasing experience, a more entertaining experience, a more hygienic experience, or the ability to promote, advertise, educate, warn and/or instruct. Greater ease or reliability of dispensing can be provided in a number of ways. First, the dispenser can be designed to operate in a similar way as the prior dispensers which offer the films in discrete pieces in a stack, but have a mechanism with a mechanical ‘finger’, perhaps with a rubber-clad tip, which drags across the top film in the stack an removes it from the container. In this way, the friction is increased as compared to a finger, the technique is designed into the mechanism and does not require human skill and can be optimized for repeatability, and since the finger does not enter the container (but rather picks off the piece of film after most of it is out of the container), the process is more hygienic. This mechanism can automatically activate as the lid is opened, so that each time the lid is opened a piece of film is offered. The mechanism can be other than a mechanical finger. It may be thus desired to use a mechanism to easily, repeatably and hygienically offer a piece of film from a stack of films to the consumer. Or the film can be packaged in roll form instead of in discrete pieces. The film can then be dispensed much as a roll of stamps in a standard stamp dispenser or as cellophane adhesive tape from a standard tape dispenser. The film can either be perforated for separation at specific intervals, or a cutting/breaking mechanism can be included in the container, or the film can be made intentionally brittle enough to be broken off, or the tape can be bitten off or dissolved off with the mouth. The film roll can be advanced manually or by a similar mechanical device as described above where a grippy mechanical finger drags the film to unroll it, or other mechanical means to accomplish the same. The mechanical device may activate by the force and action of opening the lid of such a container. A variation of a roll would be flat pieces that are longer than an individual dose and must be cut, broken, or dissolved off from the rest of the long piece. Such roll containers or long-flat containers provide additional space in comparison with the small flat flip-top prior art containers for promotion, advertising, education, warnings, larger-print ingredient labels, instructions, and items of delight such as movie characters. A further aspect of the containers is the shape of the container itself. The shape can entertain, delight, educate, warn, instruct, promote or advertise. For example, the container can be made into the form of a cartoon character or a company symbol. A further aspect is a container which is utilitarian in addition to its containing and dispensing of the film. For example, the container may be part of a keychain or a pants belt or a child's shoe, or be designed to fit within a compartment thereof.

In FIG. 15 an example container 1501 with stacked film 1502 therein is depicted. A sheet of film 1504 may be removed when the container lid 1504 is open.

In FIG. 16, an example container 1601 with stacked film 1602 therein is depicted. The container lid 1603 includes a spring-loaded dispensing finger 1605 for dispensing a piece of film 1604 for consumption.

In FIG. 17, an example container 1701 with rolled film 1702 therein is depicted. The film exits the container at a suitable opening and a weakened or perforated portion of the film 1704 is provided for easy removal of a single piece of film 1703 for consumption.

In FIG. 18, an example container 1801 with rolled film 1802 therein is depicted. The container has a lid 1804 that incorporates a spring loaded dispensing finger 1805 that serves to extract a piece of film 1803 from an opening on the container.

Methods for Making Film and Snacks

Methods for making films that can be adapted to making the snacks are documented in the following references each is which is hereby incorporated by references in its entirety: U.S. Pat. Nos. 4,713,243; 5,700,478; 5,948,430; 6,177,096; and 6,284,264; Japanese Patent No. JP-A-05-236885; and United States Patent Application Publication Nos.: US 2001/0046511; US 2001/0022964; and US 2002/0131990.

The materials of the desired film are first mixed in liquid form. Solvents may be used to achieve the mixture, such as water, water-dispersable polymers, alcohols, or other solvents.

For example, the films may be cast, molded, extruded, poured or sprayed. A moving belt or drum with or without a backing paper, or any other suitable surface or carrier can be used for receiving the material, hardening/drying or solidifying it, cutting/slitting/shaving/removing it. A drying phase may be employed such as air drying, baking, vacuum drying or dehydrating, such as with circulating warm air. When dry, the film may proceed to a rolling station where it is rolled up for later cutting and packaging.

If a carrier is used, the carrier material should have a surface tension which allows the polymer solution to spread evenly across the intended coating width without soaking in to form a destructive bond between the two. Examples of suitable materials include non-siliconized polyethylene terephthalate film, non-siliconized kraft paper, polyethylene-impregnated kraft paper, or non-siliconized polyethylene film.

The coating of the solution onto the carrier material can be performed using any conventional coating equipment. A more useful coating technique would involve a knife-over-roll coating head.

The thickness of the resulting film depends on the concentration of solids in the coating solution and on the gap of the coating head and can vary between 5 and 200 .mu.m. Drying of the film can carried out in a high-temperature air-bath using a drying oven, drying tunnel, vacuum drier, or any other suitable drying equipment, which does not adversely affect the active ingredient(s) or flavor of the film.

Some methods for preparing films are capable of encapsulating the oil ingredients (if any) within the film-forming matrix and maintaining the integrity of the film, even when the film contains oils in amounts of 10 wt % or more.

In certain methods for preparing films according to the invention, the film-forming ingredients are mixed and hydrated with water separately from the water-soluble ingredients, which are mixed in aqueous solution separately from the organic ingredients and surfactants. In these methods, the final formulation may be produced by mixing the film-forming phase with the aqueous phase, then mixing in the organic phase, which includes surfactants, such as Polysorbate 80 and Atmos 300. This mass is mixed until emulsified. In other embodiments, the aqueous and film forming phases are combined into a single phase by dissolving the water soluble ingredients in the water and then adding the gums to hydrate. The organic phase is then added to this single aqueous phase.

The resulting formulation is cast on a suitable substrate and dried to form a film. The film may be air-dried or dried under warm air and cut to a desired dimension, packaged and stored. The film can contain from about 0.1% to about 10 wt % moisture, preferably from about 3% to about 8 wt % moisture, even more preferably from about 4 to about 7 wt % moisture.

The film-forming phase can include pullulan and stabilizing agents such as xanthan gum, locust bean gum and carrageenan. These ingredients are mixed and then hydrated in water for less than about 1 to more than about 48 hours to form a gel. The water may be heated to a temperature of less than about 25 to about 45 more than about degrees C. to promote hydration. The amount of water may be about 40 to 80% of the gel. The resulting hydrated gel may be chilled to a temperature of about 20 to about 30 degrees C. for about 1 to about 48 hours. The water may be deionized.

The film-forming ingredients may be hydrated and mixed without heating due to an ionic effect known as the Donnan equilibrium.

Hydrating the film-forming agents in the presence of electrolytes in solution effectively lowers the viscosity of the polymer gel being formed, thus increasing the efficiency of the hydrating process.

The water-soluble ingredients of the formulation provide the electrolytes, which are dissolved in the hydration solution prior to addition of the film-forming ingredients.

High-shear mixing also accelerates hydration.

Hydration delumps the powders, providing greater it surface area for water contact.

In addition, local heating effects, generated in the shear regions, provide energy for hydration without substantially raising the temperature of the mass.

DISSOLVING OR DISINTEGRATING SNACK

Many of the snacks disclosed herein will solvate in the saliva found in the human mouth and dissolve or disintegrate completely within 60 seconds, or within 45 seconds, or within 30 seconds, or within 20 seconds or within 15 seconds or within 10 seconds, or within 5 seconds, or within some other time interval. A snack will be considered to have dissolved or disintegrated completely at such time as it has converted substantially to a syrup or liquid or has broken into particles of such size and mass as to be difficult for the human tongue to detect by size and shape, although the flavor and other sensations of the snack linger. If the snack exhibits the qualities of softness, flexibility and wettability, those qualities should accelerate the time at which the tongue cannot detect the film of the snack.

Mass or Interior Volume

The snacks disclosed herein typically are small sized for placement in a human mouth, and thin to encourage rapid dissolution or disintegration. Films used in the snacks disclosed herein may be of any desired thickness, length and width. An example pliable and easily soluble, edible film may be from less than about 0.0005 inches thick to more than about 0.100 inches thick, such as from about 0.001 to about 0.002 inches thick. Length and width may be chosen so that the snack fits easily on a human tongue with or without folding, such as less than about 1.5 inches in width or length.

In a snack having such dimensions, there is little interior volume and little mass. The mass of some of the example snacks will typically range from 0.03 to 0.10 grams although other masses are possible. The interior volume of some of the example snacks will range from 0.001 to 0.003 cubic inches although other interior volumes are possible. Such low interior volume leaves little room for flavor, sweetener and other ingredients. In addition, use of too much typical candy flavor results in bitterness. As described in greater detail below however, strongly flavored non-bitter snacks have been achieved. Fruit flavored and sour fruit flavored snacks are examples.

Snack Examples:

The following examples illustrate some ways to implement the snacks. The examples are considered to be illustrative only and are in no way limiting. Two example base film formulations are used to which other ingredients are added that make each example film unique. The examples will refer to base film formulations, in which the numbers represent parts by weight:

Base Film Formulation A:

28.74 Corn starch (film former)

20.92 Gelatin (film former)

12.55 Casein (binder, emulsifier, film former)

8.37 Carrageenan (film former, thickener)

7.32 Glycerin (plasticizer)

6.28 Sorbitol (plasticizer)

6.28 Sorbitan Fatty acid ester (surfactant)

5.75 Sucrose Fatty acid ester (emulsifier, dispersant)

1.05 Aspartame (sweetener)

1.05 Acesulfame K (sweetener)

0.35 Sucralose (sweetener)

1.36 Tartaric Acid (saliva enhancer)

100.00

This is a pullalun-free tripartite sweetener film formulation. To this basic formlation is added distilled water (in sufficient quantity that given the other ingredients to be added to this base formulation, the fully hydrated mixture is of the proper viscosity for the type of film making equipment used, for example 1,000 cps. The materials are allowed to hydrate under slow mixing until the ingredients are fully hydrated, then allowed to stand 24 hours under refrigerated conditions.

Base Film Formulation B:

95.29 Pullulan—PF20 by Hayashibara

2.06 Atmos 300 (surfactant)

0.55 Acesulfame potassium (sweetener)

0.55 Aspartame (sweetener)

0.18 Sucralose (sweetener)

1.38 Tartaric acid (saliva enhancer)

100.00

To this is added distilled water (in sufficient quantity that given the other ingredients to be added to this base formulation, the fully hydrated mixture is of the proper viscosity for the type of film making equipment used, for example 1,000 cps. The materials are allowed to hydrate under slow mixing until the ingredients are fully hydrated, then allowed to stand for 24 hours under refrigerated conditions.

### Example 1

5.95 parts of highly-concentrated oil-soluble natural and artificial orange flavoring from Flavors of North America, Carol Stream, Ill. are added to Base A, along with 11.4 parts of additional citric acid to enhance the flavor and the salivary response, and the mixture is thoroughly blended and made into film on an endless stainless steel belt system with no backing paper. The dried film is spooled into rolls. The film is then fed from the rolls into a printer which uses vegetable based inks to print a company logo and company name repetitively, through an ink dryer, and into an automated cutter/packager which puts discrete pieces of 0.8 inches by 1.2 inch by 0.0018 inch film in stacks of 32 pieces. The flat flip-top container into which the discrete pieces of film are stacked is outfitted with a rubber-coated spring-loaded mechanical finger which activates in conjunction with the lid opening to drag one piece of film from the stack under uniform spring-loaded tension. The film is placed on the tongue of a consumer and provides powerful, non-bitter fresh-orange flavor and a medium degree of tartness. The flavor lasts for more than one minute as the oil-soluble flavor coats the oral cavity and lingers. As the lid is closed, the mechanical finger retracts and lays parallel to the flat box, ready for the next opening of the lid. The printing on the roll of film is situated so that when the film is cut into discrete pieces, each piece has the desired printing of a company logo (graphic) and name (text).

### Example 2

5.84 parts of highly-concentrated oil-soluble artificial grape flavoring from Flavors of North America are added to Base B, along with 11.65 parts of additional citric acid to enhance the flavor and the salivary response, and the mixture is thoroughly blended and made into film on conveyor belt with backing paper. The dried film and backing paper are spooled into rolls. The film and backing paper are then fed from the rolls into a printer which uses vegetable based inks to print a series of color photographs of zoo animals repetitively, through an ink dryer, through a take-up system which separates the film from the backing paper, and into an automated slitter/cutter/packager which creates small rolls of 1.1-inch diameter. When completely unrolled, the piece of film (if not cut or broken off) is 0.8 inches wide by 40 inches long by 0.0016 inch. The rounded-box flip-top container into which the discrete pieces of film are stacked is outfitted with a rubber-coated spring-loaded mechanical finger which activates in conjunction with the lid opening to advance the roll of film by a distance of 1.2 inches under uniform spring-loaded tension. The lid is snapped shut which cuts the film at 1.2 inches long. The cut piece of film is placed on the tongue of a consumer and provides powerful, non-bitter grape flavor and a medium degree of tartness. The flavor lasts for more than one minute as the oil-soluble flavor coats the oral cavity and lingers. As the lid is closed, the mechanical finger retracts and lays parallel to the lid of the box, ready for the next opening of the lid. The printing on the original roll of film is situated so that when the film is slit and cut into discrete smaller rolls, each smaller roll has the desired printing of zoo animal photographs.

### Example 3

5.86 parts of highly-concentrated oil-soluble natural and artificial lemon flavoring from Flavors of North America are added to Base A, along with 5.10 parts of additional tartaric acid and 21.9 parts of additional citric acid to promote a sour-lemon flavor and a high salivary response, and the mixture is thoroughly blended and made into film on an endless stainless steel belt system with no backing paper. The dried film is fed directly from the stainless steel belt into a printer which uses inks made of Base A to which spearmint oil has been added at 20% of the ink weight, which prints the brand name of the film product repetitively, then through an ink dryer and into an automated slitter/cutter/packager which creates small rolls of 1.1-inch diameter. When completely unrolled, the piece of film (if not cut or broken off) is 0.8 inches wide by 40 inches long by 0.0016 inch. The rounded-box flip-top container into which the discrete pieces of film are stacked has a hinged lid that snaps open and shut. The film is perforated by the cutting/packaging equipment at 1.2-inch intervals, so that when the film is unrolled, it can be torn off easily. After a piece is torn off, the lid is closed to ensure cleanliness of the remaining pieces. The cut piece of film is placed on the tongue of a consumer and provides powerful, non-bitter lemon flavor and a high degree of sourness/tartness, and a hint of spearmint flavor from the flavored ink. The two flavors lasts for more than one minute as the oil-soluble flavor coats the oral cavity and lingers. The tartness is powerful but begins to fade more quickly than the flavors.

### Example 4

5.86 parts of highly-concentrated oil-soluble natural and artificial raspberry flavoring from Flavors of North America are added to Base A, with the exception that the plasticizers glycerin and Sorbitol are cut in half to make the film slightly more brittle. This is to facilitate the breaking off described below in this paragraph. The mixture is thoroughly blended and made into film on an endless stainless steel belt system with no backing paper. The dried film is fed directly from the stainless steel belt into a printer which uses inks made of Base A to which tartaric acid and citric acid have been added at 10% and 20% of the ink weight respectively, which prints the trade name of the flavor (for example “Raging RazzberryTm”) of the film product along with cartoon representations of raspberries repetitively, then through an ink dryer and into an automated slitter/cutter/packager which creates small rolls of 1.1-inch diameter. When completely unrolled, the piece of film (if not broken off) is 0.8 inches wide by 40 inches long by 0.0016 inch. The rounded-box flip-top container into which the discrete pieces of film are stacked has a hinged lid that snaps open and shut. When the lid is opened and the film is partially unrolled, since the film is slightly brittle due to the reduction of plasticizers, it breaks off easily by bending. The user can create a piece as long as desired and is not limited to discrete pieces of size specified by the manufacturer. After a piece is torn off, the lid is closed to ensure cleanliness of the remaining pieces. The broken-off piece of film is placed on the tongue of a consumer and provides powerful, non-bitter raspberry flavor and, due to the acidified ink, a degree of sourness/tartness. The instructions on the package indicate that the printed side should contact the tongue, and the result is that the sourness is tasted even before the raspberry flavoring. The raspberry flavor lasts for more than one minute as the oil-soluble flavor coats the oral cavity and lingers. The tartness begins to fade more quickly than the flavor.

### Example 5

5.86 parts of highly-concentrated oil-soluble artificial cherry flavoring from Flavors of North America are added to Base A, along with 0.5 parts of FD&C red dye and 12.1 parts of citric acid. The mixture is thoroughly blended and made into film on an endless stainless steel belt system with no backing paper. The dried film is spooled into rolls. The film is then fed from the rolls into an automated slitter/cutter/packager which creates small rolls of 1.1-inch diameter. When completely unrolled, the piece of film (if not yet cut) is 0.8 inches wide by 40 inches long by 0.0016 inch. The rounded-box flip-top container into which the discrete pieces of film are stacked has a hinged lid with a metal cutter blade that snaps open and shut. When the lid is opened and the film is partially unrolled, then the lid shut, the cutter blade cuts off a discrete piece of film. The user can create a piece as long as desired and is not limited to discrete pieces of size specified by the manufacturer. After a piece is cut off, the lid is closed to ensure cleanliness of the remaining pieces. The broken-off piece of film is placed on the tongue of a consumer and provides powerful, non-bitter cherry flavor and a medium degree of sourness/tartness. The film is brightly and deeply colored red. The raspberry flavor lasts for more than one minute as the oil-soluble flavor coats the oral cavity and lingers.

### Example 6

5.25 parts of highly-concentrated oil-soluble artificial blueberry flavoring from Flavors of North America are added to Base B, along with 2 parts of additional maleic acid and 1.2 parts of FD&C blue dye, and the mixture is thoroughly blended and made into film on an endless stainless steel belt system with no backing paper. The dried film is spooled into rolls. The film is then fed into an automated cutter/packager which puts discrete pieces of 0.8 inches by 8 inch by 0.002 inch film in stacks of 50 pieces. The flat flip-top container into which the discrete pieces of film are stacked is an elongated box with the hinged side along the 8-inch length. The top is snapped open, and one piece is removed. The consumer can choose to put the end in his/her mouth and continuously dissolve it off, or to break it off and put a smaller piece in the mouth. The film is placed on the tongue of a consumer and provides powerful, non-bitter blueberry flavor and a medium-low degree of tartness. The flavor lasts for more than one minute as the oil-soluble flavor coats the oral cavity and lingers. The film is deeply and brightly colored blue, and after eating an 8-inch long piece of film, the consumers tongue is colored brightly blue.

### Example 7

Two formulations are made. 6.2 parts of highly-concentrated oil-soluble natural and artificial beef flavoring from Flavors of North America are added to Base A, along with 0.15 parts of FD&C dyes formulated to make brown dye, and the mixture is thoroughly blended. 3.3 parts of highly-concentrated oil-soluble artificial green pepper flavoring from Flavors of North America are added to Base A, along with 0.20 parts of FD&C green dye, and the mixture is thoroughly blended. Using a multiple feed stream arrangement, the two differently colored and differently flavored compounds are made into film on an endless stainless steel belt system with no backing paper. The colors/flavors alternate approximately every 0.25 inches, creating a striped effect. The dried film is spooled into rolls. The film is then fed into an automated cutter/packager which puts discrete pieces of 0.8 inches by 8 inch by 0.002 inch film in stacks of 50 pieces. The flat flip-top container into which the discrete pieces of film are stacked is an elongated box with the hinged side along the 8-inch length. The top is snapped open, and one piece is removed. The consumer can choose to put the end in his/her mouth and continuously dissolve it off, or to break it off and put a smaller piece in the mouth. The film is placed on the tongue of a consumer and provides a craving-satisfying flavor combination representing a main course of a dinner. The container being 8 inches long provides sufficient space to print ingredients in a manner large enough to be easily read, in addition to the product identifying and marketing information and graphics, so that a separate blister pack and backing card are not required.

### Example 8

Two formulations are made. 6.2 parts of highly-concentrated oil-soluble natural and artificial beef flavoring from Flavors of North America are added to Base B, along with 0.15 parts of FD&C dyes formulated to make brown dye, and along with 1.1 parts of salt (sodium chloride), and the mixture is thoroughly blended. 3.3 parts of highly-concentrated oil-soluble artificial green pepper flavoring from Flavors of North America are added to Base B, along with 0.20 parts of FD&C green dye, and the mixture is thoroughly blended. The beef-flavored component is made into a film, dried on line, and then the green pepper-flavored component is cast onto top of it, making a two-layer, two-color, two-flavor film. Each layer of film is 0.001 inches thick, and the total film is 0.002 inches thick. The dried film is spooled into rolls. The film is then fed from the rolls into an automated cutter/packager which puts discrete pieces of film in stacks of 32 pieces into flat flip-top containers which have in their peripheral shapes the company logo of the company marketing the films for use by dieters.

### Example 9

6.5 parts of highly-concentrated oil-soluble natural and artificial french fry flavoring from Flavors of North America are added to Base A, along with 0.08 parts of FD&C yellow dye, 2 parts of salt (sodium chloride), and 4.2 parts of soybean oil, and the mixture is thoroughly blended and made into a film. The dried film is spooled into rolls. The film is then fed from the rolls into an automated cutter/packager which puts discrete pieces of film in stacks of 24 pieces into flat flip-top containers. A ring and chain are installed onto each container to make a key chain. The film tastes like french fries, including the satisfaction of a minor amount of fat and salt, satisfying cravings for such foods at a small fraction of the calories, fat, and salt of regular french fries.

### Example 10

4.2 parts of highly-concentrated oil-soluble natural and artificial custard flavoring from Flavors of North America are added to Base B, along with 0.10 parts of FD&C yellow dye, and 2.8 parts of concentrated vanilla extract, and the mixture is thoroughly blended and made into a film. The dried film is spooled into rolls. The film is then fed from the rolls into an automated cutter/packager which puts discrete pieces of film in stacks of 24 pieces into flat flip-top containers. The film tastes like vanilla custard dessert, satisfying cravings for desserts at a small fraction of the calories, fat, and salt of real vanilla custard.

### Example 11

5.3 parts of highly-concentrated oil-soluble artificial butterscotch flavoring from Flavors of North America are added to Base A, along with 0.1 parts of FD&C yellow dye, 0.05 parts of FD&C red dye, 0.02 parts of FD&C green dye, and 3.0 parts of coconut oil, and the mixture is thoroughly blended and made into a film. The dried film is spooled into rolls. The film is then fed from the rolls into an automated cutter/packager which die cuts the film into 16-pointed stars in the caricature of a shining sun and puts sun-shaped, butterscotch-colored pieces of film in stacks of 24 pieces into flat flip-top containers with a circular shape. The film tastes like butterscotch candy, including the satisfaction of a minor amount of fat, satisfying cravings for such candy at a small fraction of the calories and fat as compared to butterscotch hard candies.

### Example 12

5.3 parts of highly-concentrated oil-soluble natural & artificial apple flavoring and 1.4 parts of highly-concentrated oil-soluble artificial cream flavoring both from Flavors of North America are added to Base B, along with 0.3 parts of FD&C green dye, 0.6 parts of cinnamon oil, 0.05 parts of salt (sodium chloride), and 2.2 parts of sunflower oil, and the mixture is thoroughly blended and made into a film. The dried film is spooled into rolls. The film is then fed from the rolls into an automated cutter/packager/embosser which embosses and die cuts the film into a three dimensional apple shape open at the bottom. These pieces are stacked nested 32 deep and put into flat flip-top containers with an apple shape. The film tastes like baked apples with cream and cinnamon, including the satisfaction of a minor amount of fat, satisfying cravings for desserts in a healthy way.

### Example 13

5.8 parts of highly-concentrated oil-soluble artificial popcorn flavoring from Flavors of North America are added to Base A except that no water is used, along with 0.3 parts of FD&C yellow dye and 4.8 parts of peanut oil, and the mixture is thoroughly blended and input to the feed throat of an extruder. A heated die is attached to the extruder which extrudes thin film in a hollow shape with a five-pointed star cross section. The pullulan, being a thermoplastic, lends itself to thermoplastic processes such as extrusion. Immediately downstream from the die a cutter chops the 1 inch diameter star-shaped pieces into 0.25 inch thick pieces. The pieces are dropped into boxes and closed. The film tastes like popcorn, including the satisfaction of a minor amount of fat, satisfying cravings for snacks at a small fraction of the calories and fat as compared to real buttered popcorn. However, it lacks the salt that helps typical popcorn taste good, so it is bland. The three-dimensional shape provides an interesting change from flat films, dissolving on the tongue while providing some texture.

### Example 14

5.8 parts of highly-concentrated oil-soluble artificial popcorn flavoring from Flavors of North America are added to Base A except that no water is used, along with 0.3 parts of FD&C yellow dye and 2.2 parts of salt (sodium chloride), and the mixture is thoroughly blended, made into film, and flat-packed in stacks of 32 rectangular pieces. The film tastes like popcorn, including the satisfaction of a minor amount of salt, satisfying cravings for snacks at a small fraction of the calories and fat as compared to real salted popcorn. However, it lacks the fat that helps typical popcorn taste good, so it is not as satisfying as if fat were added.

### Example 15

Same as Example 14 except that 4.8 parts of peanut oil are added. Now, with both salt and fat added to the popcorn flavor, the film is very satisfying in place of real popcorn which has much higher levels of calories, fat, and salt.

### Example 16

5.5 parts of highly-concentrated oil-soluble artificial spearmint and other mints flavoring from Flavors of North America are added to Base A, along with 0.45 parts of FD&C green dye, and the mixture is thoroughly blended. A chewable candy with L-menthol is made by standard candy methods, then the spearmint film is coated on with pill coating equipment. The resultant pill is put into the mouth and sucked on. The first sensation is a pleasing spearmint candy taste, and then when the film dissolves away, the second sensation (while the spearmint and sweetener are still lingering in the mouth) is the cool breath-freshening effect of the menthol as the inner candy is chewed. Alternatively, biocidal agents can be added as well to prevent bad breath, plaque, gingivitis, and the like.

### Example 17

5.8 parts of highly-concentrated oil-soluble natural & artificial apple flavoring from Flavors of North America are added to Base A, along with 0.23 parts of FD&C green dye, and the mixture is thoroughly blended, the amount of water and gelatin being compatible with capsule forming techniques. The compound is then made into two-part capsules. Separately, a hard candy is made by known methods with sugar and highly-concentrated oil-soluble artificial red hot flavoring from Flavors of North America, then ground into powder. This powder is put into the capsules and the capsule halves joined. The resultant capsule is put into the mouth and sucked on. The first sensation is a pleasing apple candy taste, and then when the film dissolves away, the second sensation (while the cherry and sweetener are still lingering in the mouth) is the red hot spicy effect of the hard candy powder as the powder dissolves in the mouth.

### Example 18

5.3 parts of highly-concentrated oil-soluble artificial cherry flavoring from Flavors of North America are added to Base A, along with 0.08 parts of FD&C red dye, and the mixture is thoroughly blended, the amount of water and gelatin being compatible with gelatin encapsulation techniques. Separately, a mixture is made of soybean oil and numbing ingredients such as are found in the over-the-counter sore-throat numbing spray “Chloraseptic”. The numbing oil mixture is encapsulated into the cherry flavored film with the type of equipment used for vitamin E soft-gels. The resultant soft-gel is put into the mouth and sucked on. The first sensation is a pleasing cherry candy taste, and then when the film dissolves away, the consumer swallows the numbing oil to numb the throat while the pleasant cherry and sweetener taste linger in the mouth. This is more acceptable and pleasant to young children than the gagging effect of a numbing spray.

### Example 19

5.84 parts of highly-concentrated oil-soluble artificial red hot flavoring from Flavors of North America are added to Base A and the mixture is thoroughly blended and made into film by the method of Example 1. When the rectangular piece of film is placed on the tongue and the tongue rubbed against the roof of the mouth, a robust cinnamon-based and jalapeno-based and clove-based hot candy flavor is evidenced, lingering for well over a minute. Although there is sufficient citric acid in the Base A to stimulate saliva flow, no tartness is noted in the film taste.

### Example 20

5.95 parts of highly-concentrated oil-soluble natural and artificial orange flavoring from Flavors of North America, along with 5.0 parts tartaric acid and 20.0 parts citric acid are added to Base A and the mixture is thoroughly blended and made into film by the method of Example 1. When the film is ingested in the oral cavity, a powerfully sour/tart fresh-orange flavor is evidenced, with the orange flavor lingering longer than the sourness. If Base B is used instead of Base A, then since Base B has pullulan instead of starch, the low pH only has a minor effect on the film, causing slight brittleness.

### Example 21

5.84 parts of highly-concentrated oil-soluble artificial grape flavoring from Flavors of North America are added to Base A and the mixture is thoroughly blended and made into film by the method of Example 1. As the film is in a still wet but in a nearly dried out state on its way down the stainless steel belt, citric acid powder diluted with maltodextrin is sprinkled on the surface and adheres in the tacky surface of the film without dissolving to any great extent. When the film is ingested in the oral cavity, a powerfully sour/tart grape flavor is evidenced, with the sourness experienced first (if the film is placed on the tongue acid-side first), then the grape flavor being experienced and lingering longer than the sourness. Because the citric acid is on the film rather than in it, the physical properties of the film are not affected adversely as they would be if the starch-based film was very low pH due to the inclusion of this much acid.

### Example 22

Two formulations are made. 5.82 parts of highly-concentrated oil-soluble natural and artificial apple flavoring from Flavors of North America are added to Base A, along with 0.3 parts of FD&C green dye, and the mixture is thoroughly blended. 3.3 parts of highly-concentrated oil-soluble natural and artificial cranberry flavoring from Flavors of North America are added to Base A, along with 0.17 parts of FD&C red dye and 0.12 parts of FD&C blue dye, and the mixture is thoroughly blended. Films are separately made from each formulation. The films are then adhered to one another with a mixture of binder (such as pullulan) and citric and tartaric acids sufficient to produce the level of tartness as in example 21. The cran-apple flavor is exceptionally sour, which is pleasing to many people, especially children. Because the citric acid is between the film layers rather than in it, the physical properties of the film layers are not affected adversely as they would be if the starch-based film was very low pH due to the inclusion of this much acid.

### Example 23

5.72 parts of highly-concentrated oil-soluble artificial fresh watermelon flavoring from Flavors of North America are added to Base B and the mixture is thoroughly blended and made into film by the method of Example 21, with the blend of citric acid and maltodextrin being replaced by a blend of two microencapsulated acids. One of the microencapsulated acids (145-72L Citric Acid from Loders Croklaan company of Channahon, Ill.) causes a delay of a few seconds before the sourness of the acid is tasted, and the second microencapsulated acid (150-80VS Citric Acid from Loders Croklaan company) causes a longer delay. Because of the variability of the thickness of the encapsulation, the sourness lasts a long time, even over one minute, so that the flavor and the sourness stay together unlike earlier stated examples of sour films.

### Example 24

Pressurized-gas candy powder as described earlier, made with a spearmint flavor, is put into an envelope or pouch made of a cherry-flavored film based on Base B and heat-sealed shut, taking advantage of the thermoplastic nature of the pullulan. The consumer gets a two-part flavor experience, with the flavors being different in timing, and then as the pressure is released from the candy powder, gets a noisy crackling effervescent experience.

### Example 25

5.84 parts of highly-concentrated oil-soluble artificial grape flavoring from Flavors of North America are added to Base A and the mixture is thoroughly blended and made into film by the method of Example 1. As the film is in a still wet but nearly dried out state on its way down the stainless steel belt, grape-flavored pressurized-gas candy powder is sprinkled on the surface and adheres in the tacky surface of the film without dissolving to any great extent. When the film is ingested in the oral cavity, a grape candy flavor is evidenced along with noisy crackling effervescence.

### Example 26

Same as Example 22 except that the citric and tartaric acids between layers is replaced by apple-flavored powdered pressurized-gas candy. Instead of a sour cran-apple, a noisy crackling effervescent sweet cran-apple is experienced.

### Example 27

A two-layer film is made with complementary flavors in each layer. One layer is high in citric acid, and the other layer is high in sodium bicarbonate. They are adhered together with a binder. When dissolved by saliva in the mouth, the acid and the sodium bicarbonate combine and the reaction produces carbon dioxide gas. A pleasing, mouth-filling, mouth-coating effervescence results.

While snacks have been described and illustrated in conjunction with a number of specific ingredients, materials and configurations herein, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations of snacks described herein are to be considered in all respects as only illustrative, and not restrictive. All changes which come within the meaning and range of equivalency of the claims are to be embraced within their scope.

1. A snack of orally soluble edible film comprising:
one or more layers of film,
said film being orally soluble such that it disintegrates quickly upon placement in a human mouth without leaving substantial residue that can be felt by the human tongue or which needs to be swallowed or ejected from the mouth;
at least one flavoring present in said film, said flavoring providing a strong flavor sensation to a person who places the snack on his or her tongue.

2. A snack as recited in claim 1 further comprising:
a sweetener present in said film, said sweetener providing a strong sensation of sweetness to a person who places the snack on his or her tongue.

3. A snack as recited in claim 1 further comprising:
an encasement layer formed from at least a portion of said film,
said encasement layer being formed to at least partially enclose another material desired to be present in said snack.

4. A snack as recited in claim 1 further comprising:
an encasement layer formed from at least a portion of said film, and
an acidic layer formed on the exterior surface of said film, said acidic layer tending to enhance the tartness sensation experienced by a person who places the snack on his or her tongue.

5. A snack as recited in claim 1 further comprising:
an exterior tartness layer presented on at least a portion of the exterior of said film,
said tartness layer begin formed of a material which tends to introduce a sharp or sour flavor sensation to a person who places the snack on his or her tongue.

6. A snack as recited in claim 1 further comprising:
an optical representation on or in said film, said optical representation serving a purpose selected from the group consisting of:
(i) increasing the attractiveness of the snack to a consumer in a retail location,
(ii) encouraging the consumer to experience a pleasant thought while consuming the snack, or
(iii) advertising products or services unrelated to the snacks themselves.

7. A snack as recited in claim 6 wherein said optical representation is selected from the group consisting of:
embossing located on the exterior of said film,
an image located within said film,
an image applied to the exterior said film, and
an image sculpted in said film.

8. A snack as recited in claim 7 wherein said optical image is selected from the group consisting of text, words, figures, logos, graphics, characters, art, advertising and educational materials.

9. A snack as recited in claim 1 further comprising:
an optical representation on or in said film,
said optical representation being selected from the group consisting of:
embossing located on the exterior of said film,
an image located within said film,
an image applied to the exterior said film, and
an image sculpted in said film, and
wherein said optical image being selected from the group consisting of text, words, figures, logos, graphics, characters, art and advertising.

10. A snack as recited in claim 1 wherein said film has a thickness in the range of from about 0.0005 to about 0.100 inches.

11. A snack as recited in claim 1 wherein said film has a thickness in the range of from about 0.001 to about 0.002 inches.

12. A snack as recited in claim 1 wherein length and width of said snack are chosen so that the snack fits easily on a human tongue without folding.

13. A snack as recited in claim 1 wherein length and width of said snack are each less than a maximum of about 1.5 inches.

14. A snack as recited in claim 1 wherein said film is substantially free of L-Menthol.

15. A snack as recited in claim 1 wherein said film has been formed without use of L-Menthol as a plasticizer.

16. A snack as recited in claim 1 wherein said film is brightly colored.

17. A snack as recited in claim 1 wherein said film has multiple colors.

18. A snack as recited in claim 16 or 17 wherein consumption of said snack causes the consumer's tongue to assume a color other than its natural color.

19. A snack as recited in claim 1 wherein said film includes a glow in the dark ingredient.

20. A snack as recited in claim 19 wherein consumption of the snack causes the consumer's tongue to glow in the dark.

21. A sweetened non-medicated snack of orally soluble edible film comprising:
at least one layer of film,
said film being orally soluble such that it disintegrates quickly upon placement in a human mouth without leaving substantial residue that can be felt by the human tongue or which needs to be swallowed or ejected from the mouth;
at least one flavoring present in said film, said flavoring providing a strong flavor sensation to a person who places the snack on his or her tongue;
at least three sweeteners being present in said film, said sweeteners being present in equal amounts of sweetness without regard to equal amounts of mass or equal amounts of volume;
wherein said film forming agent is selected from the group consisting of pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, polysaccharides, natural gums, polypeptides, polyacrylates, starch, karaya gum, gum arabic; guar gum; locust bean gum; carageenan gum; acacia; karaya; ghatti; tragacanth agar; tamarind gum; xanthan gum; gelatin; hydrocolloid flour; guar gum; locust bean; microcrystalline cellulose; tara; cellulose ethers; seaweed extract, alginates; carageenans; konjac; pectin; arabinoglactan; modified starches; natural gums; edible polymers; hydrocolloid flours; seaweed extracts; land plant extracts; derivatives thereof; and combinations thereof.

22. A sweetened non-medicated snack of orally soluble edible film as recited in claim 21 further comprising a film forming agent; and wherein said film forming agent is present in said film in an amount ranging from about 30 to about 80 weight percent of the finished film.

23. A sweetened non-medicated snack of orally soluble edible film as recited in claim 21 further comprising a film forming agent; and wherein said film forming agent is a cellulose ether selected from the group consisting of methylcellulose; ethylcellulose; hydroxymethylcellulose; hydroxyethylcellulose; hydroxypropylmethylcellulose; carboxymethylcellulose; and derivatives thereof and combinations thereof.
